(19) United States
(12) Patent Application Publication
(10) Pub. No.: US 2025/0266896 A1
(43) Pub. Date: Aug. 21, 2025

(54) BEAM FAILURE PROCESSING METHOD, DEVICE, AND READABLE STORAGE MEDIUM

(71) Applicant: VIVO MOBILE COMMUNICATION CO., LTD., Dongguan (CN)

(72) Inventors: Kun YANG, Dongguan (CN); Jinhua LIU, Dongguan (CN); Huan WANG, Dongguan (CN)

(73) Assignee: VIVO MOBILE COMMUNICATION CO., LTD., Dongguan (CN)

(21) Appl. No.: 19/203,284

(22) Filed: May 9, 2025

Related U.S. Application Data
(63) Continuation of application No. PCT/CN2023/128029, filed on Oct. 31, 2023.

(30) Foreign Application Priority Data
Nov. 10, 2022 (CN) 202211408399.8

(51) Int. Cl. H04B 7/06; H04B 17/318

(52) U.S. Cl. CPC H04B 7/06964; H04B 17/318

(57) ABSTRACT

A beam failure processing method, a device, and a readable storage medium are provided. The method includes: obtaining, by a first communication device, a beam failure detection (BFD) result of a first link; and performing, by the first communication device, a processing operation based on the beam failure detection result of the first link, where the first communication device is a relay device between a network side and a terminal side, the first communication device includes a first module, and the first link is a control link between the first module and the network side.

### CROSS-REFERENCE TO RELATED APPLICATIONS

This application is a continuation of International Application No. PCT/CN2023/128029, filed Oct. 31, 2023, which claims priority to Chinese Patent Application No. 202211408399.8, filed Nov. 10, 2022. The entire contents of each of the above-referenced applications are expressly incorporated herein by reference.

### TECHNICAL FIELD

This application pertains to the field of communication technologies, and specifically relates to a beam failure processing method, a device, and a readable storage medium.

### BACKGROUND

After a network controlled repeater (NCR) is introduced into a network, a terminal can amplify and forward radio signals by using the NCR, thereby implementing communication with a base station. Due to changes in a wireless environment, channels (backhaul link and control link) between the NCR and the base station may experience quality degradation, such as beam failures. Currently, no beam failure processing manner is clearly defined for the NCR.

### SUMMARY

Embodiments of this application provide a beam failure processing method, a device, and a readable storage medium.

According to a first aspect, a beam failure processing method is provided. The method includes:
obtaining, by a first communication device, a beam failure detection (BFD) result of a first link and a BFD result of a second link; and
performing, by the first communication device, a processing operation based on the BFD result of the first link and/or the BFD result of the second link, where
the first communication device is a relay device between a network side and a terminal side, the first communication device includes a first module and a second module, the first link is a control link between the first module and the network side, and the second link is a backhaul link between the second module and the network side.

According to a second aspect, a beam failure processing apparatus is provided. The apparatus is applied to a first communication device. The apparatus includes.
a first execution module, configured to obtain, by the first communication device, a BFD result of a first link and a BFD result of a second link; and
a second execution module, configured to perform, by the first communication device, a processing operation based on the BFD result of the first link and/or the BFD result of the second link, where
the first communication device is a relay device between a network side and a terminal side, the first communication device includes a first module and a second module, the first link is a control link between the first module and the network side, and the second link is a backhaul link between the second module and the network side.

According to a third aspect, a communication device is provided. The communication device includes a processor and a memory. The memory stores a program or instructions capable of running on the processor. When the program or instructions are executed by the processor, the steps of the method according to the first aspect are implemented.

According to a fourth aspect, a communication system is provided and includes a terminal, a network device, and a first communication device. The terminal communicates with the network device through the first communication device. The first communication device may be configured to perform the steps of the method according to the first aspect.

According to a fifth aspect, a readable storage medium is provided. The readable storage medium stores a program or instructions. When the program or instructions are executed by a processor, the steps of the method according to the first aspect are implemented.

According to a sixth aspect, a chip is provided. The chip includes a processor and a communication interface. The communication interface is coupled to the processor. The processor is configured to run a program or instructions to implement the steps of the method according to the first aspect.

According to a seventh aspect, a computer program or program product is provided. The computer program or program product is stored in a storage medium. The computer program or program product is executed by at least one processor to implement the steps of the method according to the first aspect.

In the embodiments of this application, the first communication device obtains the BFD result of the control link and the BFD result of the backhaul link between the first communication device and the network side, and performs the processing operation based on the BFD result of the first link and/or the BFD result of the second link, to avoid a large-scale beam failure of a terminal connected to the first communication device, thereby improving communication quality.

### BRIEF DESCRIPTION OF DRAWINGS

FIG. 1 is a schematic diagram of a cascaded link architecture between a base station, an NCR, and UE;

FIG. 2 is a schematic flowchart of a beam failure processing method according to an embodiment of this application;

FIG. 3 is a schematic structural diagram of a beam failure processing apparatus according to an embodiment of this application; and

FIG. 4 is a schematic structural diagram of a communication device according to an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that the terms used in this way are interchangeable in appropriate circumstances, so that the embodiments of this application can be implemented in other orders than the order illustrated or described herein. In addition, objects distinguished by “first” and “second” usually fall within one class, and a quantity of objects is not limited. For example, there may be one or more first objects. In addition, the term “and/or” in the specification and claims indicates at least one of connected objects, and the character “/” generally represents an “or” relationship between associated objects.

It should be noted that technologies described in the embodiments of this application are not limited to a Long Term Evolution (LTE)/LTE-Advanced (LTE-A) system, and can also be used in other wireless communication systems, such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and other systems. The terms “system” and “network” in the embodiments of this application are usually used interchangeably. The described technologies may be used for the foregoing systems and radio technologies, and may also be used for other systems and radio technologies. However, in the following descriptions, the New Radio (NR) system is described for an illustrative purpose, and NR terms are used in most of the following descriptions. These technologies may also be applied to other applications than an NR system application, for example, a 6th Generation (6G) communication system.

A wireless communication system in this application includes a terminal and a network device. The terminal may be a terminal-side device such as a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR) or virtual reality (VR) device, a robot, a wearable device, vehicle user equipment (VUE), pedestrian user equipment (PUE), a smart home (a home device having a wireless communication function, such as a refrigerator, a television, a washing machine, or furniture), a game console, a personal computer (PC), a teller machine, or a self-service machine. The wearable device includes a smartwatch, a smart band, a smart headphone, smart glasses, smart jewelry (a smart bracelet, a smart wrist chain, a smart ring, a smart necklace, a smart anklet, a smart ankle chain, or the like), a smart wristband, smart clothing, or the like. It should be noted that a specific type of the terminal is not limited in the embodiments of this application. The network-side device may include an access network device or a core network device. The access network device may also be referred to as a radio access network device, a radio access network (RAN), a radio access network function, or a radio access network element. The access network device may include a base station, a wireless local area network (WLAN) access point, a Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmission and reception point (Transmission Reception Point, TRP), or another appropriate term in the art. As long as the same technical effect is achieved, the base station is not limited to specific technical terms. It should be noted that in the embodiments of this application, only a base station in an NR system is used as an example for description, but a specific type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF), an edge application server discovery function (EASDF), unified data management (UDM), a unified data repository (UDR), a home subscriber server (HSS), a centralized network configuration (CNC), a network repository function (NRF), a network exposure function (NEF), a local NEF (Local NEF or L-NEF), a binding support function (BSF), an application function (AF), or the like. It should be noted that in the embodiments of this application, only a core network device in the NR system is used as an example for description, but a specific type of the core network device is not limited.

For better understanding the technical solutions of this application, the following content is first described.

### Intelligent Signal Amplifier or Network Controlled Repeater (NCR)

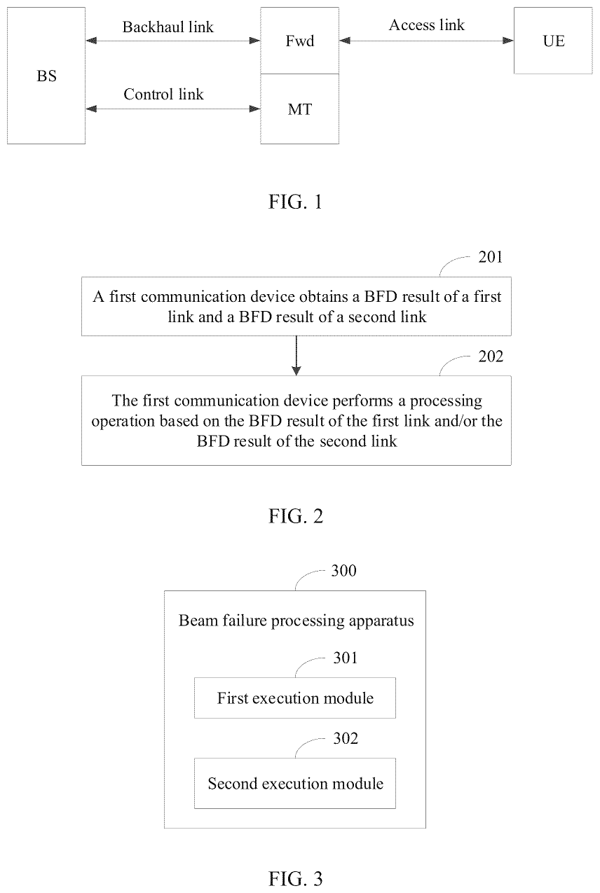

Signal amplifiers are widely used to expand coverage of cells. As a relay node, an NCR can forward signals from a base station or user equipment (UE) and amplify the signals. The NCR may receive control from an upstream base station (donor), that is, the base station may control transmission parameters of the NCR, such as receive/transmit beams between the NCR and the base station or between the NCR and the UE. A network structure shown in FIG. 1 includes three network nodes, and an intermediate network node is an NCR device, which includes a termination module (MT) and a forwarding unit (Fwd). The MT may establish a connection (by using a control link) to the upstream base station. The base station may transmit control signaling to the NCR through the MT to control transmission/reception related parameters (including power, an amplification factor, a beam, enable/disable, and other parameters) of a backhaul link (BH) between the NCR and the base station or an access link (AL) between the NCR and the UE.

Through the backhaul link and the access link, the Fwd module of the NCR establishes a cascaded BS-NCR-UE channel for communication between the base station and a terminal. The Fwd module does not perform baseband processing on a radio signal, but only performs amplification and forwarding operations and beamforming reception and transmission operations. Based on control information obtained on the control link, the NCR determines downlink transmit and uplink receive beams, and an enable time and a disable time of the access link. For an NCR with configurable beams of the backhaul link, the NCR determines the downlink receive and uplink transmit beams of the backhaul link based on the control information on the control link. More specifically, when the MT does not receive or transmit signals, the beams of the backhaul link are configured by the base station or determined according to implicit rules; or when the MT receives or transmits signals, the beams of the backhaul link are the same as beams of the MT.

### Beam Failure Detection and Recovery Procedure

After the terminal accesses a cell, the terminal periodically detects a reference signal (channel state information reference signal (CSI-RS) or a synchronization signal/physical broadcast channel signal block (or synchronization signal block) (Synchronization Signal and PBCH block, SSB)) to determine quality of a link between the base station and the terminal; and if the link quality is excessively low, the terminal needs to reselect a beam with good channel quality to update the link.

A criterion for determining the link quality of the terminal is that a physical downlink control channel block error rate (PDCCH BLER) is less than 10%. The terminal listens to a reference signal (CSI-RS or SSB) quasi-co-located with a PDCCH, and calculates equivalent PDCCH BLER performance based on a measurement result of a signal to interference plus noise ratio (signal-to-noise and interference ratio, SINR). A reference signal used for measurement may be explicitly configured by the base station, or implicitly determined by the terminal based on a reference signal in a transmission configuration indicator (TCI) configuration corresponding to a control resource set (CORESET) of the PDCCH. If the BLER measured by the terminal is lower than a predefined threshold for N consecutive times, the terminal considers that a beam failure is detected, that is, link quality is excessively low, where a value of N is predefined by a protocol.

If the terminal detects a beam failure, the terminal detects candidate beams (corresponding reference signals, CSI-RSs, or SSBs) preconfigured by a system, selects a beam meeting a channel quality condition, and initiates beam failure recovery (BFR). The channel quality condition is that layer 1 reference signal received power (L1-RSRP) is higher than a threshold. The terminal initiates contention free random access (CFRA) by using random access resources corresponding to the candidate beams. If the CFRA is successful and the BFR procedure is successful, the terminal establishes a link with the base station based on the candidate beams.

If none of the candidate beams meets the channel quality condition, the terminal detects the SSBs and sends contention based random access (CBRA), and selects an appropriate SSB to reestablish a link with the base station.

### Radio Link Failure Detection

When the UE or the BS finds that the measured RSRP is very low, or cannot decode the PDCCH and a PDSCH, the UE or the BS cannot receive an acknowledgment (ACK) or a negative-acknowledgment (NACK). The terminal cannot wait for feedback indefinitely. Therefore, a timing mechanism is used to determine whether a radio link failure occurs, that is, a timer (T311 and n310) is used. If an out-of-synchronization indication is received from a physical layer, an n310 counter is started, and when the n310 counter reaches a preset maximum value, the timer T310 is started. If the T310 timer expires, it is considered that the radio link fails, and the terminal performs radio resource control (RRC) reestablishment. If a synchronization indication or reconfiguration information is received before T310 expires, T310 is stopped, and it is considered that the link is still valid.

After the link failure, the UE performs RRC reestablishment.

Among cascaded links between the base station, the NCR, and the UE, beam failures may occur on both the backhaul link and the access link. If a beam failure occurs on the access link, the terminal may perform beam recovery according to existing BFD and BFR procedures. If a beam failure occurs on the backhaul link, beam failures also occur on all terminals under the NCR, and BFR may occur on a large number of terminals simultaneously, which leads to system congestion and affects communication quality of users. (There are two cases. In the first case, a channel in a coverage area changes suddenly, and an existing terminal mechanism cannot resolve this problem. The terminal may select a beam related to the NCR again in the BFR procedure. In the second case, if a beam failure occurs on the NCR but the base station does not know it, the base station continues to schedule the terminal to access the NCR, resulting in a beam failure of the terminal.)

Because the Fwd module of the NCR only amplifies and forwards radio signals, an SINR of a cascaded channel is definitely less than an SINR of the base station-NCR link or the backhaul link. This indicates that when the MT detects a beam failure, the terminal definitely has also detected the beam failure. Therefore, if a BFD detection threshold of the MT is excessively high or an existing threshold is directly used, the terminal frequently performs BFD and BFR procedures, and user communication quality is affected.

When beams of the backhaul link and the control link are different, the NCR does not perform baseband processing on signals of the backhaul link. Therefore, it is impossible to measure the SINR. Therefore, it is impossible to directly determine whether a beam failure occurs on the backhaul link.

From a perspective of a radio link failure (RLF), if an RLF occurs on the control link, it means that poor channel quality is likely to occur on the backhaul link. In this case, the terminal also detects an RLF.

Amplification and forwarding of radio signals with poor channel quality by the NCR does not improve signal quality of the terminal, and wastes energy of the NCR.

A beam failure processing method provided in embodiments of this application is hereinafter described in detail by using some embodiments and application scenarios thereof with reference to the accompanying drawings.

Referring to FIG. 2, an embodiment of this application provides a beam failure processing method. The method is applied to a first communication device and includes the following steps.

Step 201: The first communication device obtains a BFD result of a first link and a BFD result of a second link.

Step 202: The first communication device performs a processing operation based on the BFD result of the first link and/or the BFD result of the second link, where
the first communication device is a relay device between a network side and a terminal side, the first communication device includes a first module and a second module, the first link is a control link between the first module and the network side, and the second link is a backhaul link between the second module and the network side.

In some embodiments of this application, the first communication device may be an NCR disposed between the network side and a terminal, as shown in FIG. 1; and correspondingly, the first module is an MT, the second module is Fwd, the first link is the control link, the second link is the backhaul link, a link between the first communication device and the terminal is a third link, the third link is an access link between the second module and the terminal side, and correspondingly, the third link is the access link. It should be noted that, for clarity and ease of description of the solutions, the foregoing terms are used in the following examples. It may be understood that use of these terms is not specifically limited in the embodiments of this application.

In some embodiments of this application, the first communication device obtains the BFD result of the control link and the BFD result of the backhaul link between the first communication device and the network side, and performs the processing operation based on the BFD result of the first link and/or the BFD result of the second link, to avoid a large-scale beam failure of a terminal connected to the first communication device, thereby improving communication quality.

In an implementation, that the first communication device obtains a BFD result of a first link includes:
(1) the first communication device measures a first reference signal on the first link, where the first reference signal is a reference signal transmitted on the control link; and
(2) in a case that a measurement result of the first reference signal is lower than a first threshold, the first communication device determines that a beam failure occurs on the first link, where
the first threshold is predefined by a protocol or configured by the network side.

In some embodiments of this application, the NCR determines whether a beam failure occurs on the control link. In some embodiments, the NCR-MT performs beam failure detection, and if an SINR, an SNR, or reference signal received power is lower than the first threshold, it is considered that a beam failure occurs on the control link. The first threshold may be predefined by a protocol (SINR corresponding to PDCCH BLER=10%) or configured by a network (for example, PDCCH BLER=a, and a<10%).

In an implementation, in a case that a beam of a physical channel on the second link is the same as a beam of a physical channel on the first link, that the first communication device obtains a BFD result of a second link includes either of the following:

(1) The first communication device uses the BFD result of the first link as the BFD result of the second link.

In some embodiments of this application, the NCR determines whether a beam failure occurs on the backhaul link. For example, if a beam of the backhaul link is the same as a beam of a physical channel on the control link (for example, a same TCI configuration or a same SSB beam), the control link and the backhaul link use a same beam failure detection result. To be specific, if a beam failure occurs on the control link, it is also considered that a beam failure occurs on the backhaul link.

(2) The first communication device measures a second reference signal on the first link, and in a case that a measurement result of the second reference signal is lower than a second threshold, determines that a beam failure occurs on the second link, where the second reference signal is a reference signal transmitted on the control link, and
the second reference signal is explicitly configured or implicitly determined by a TCI configuration of the second link, and the second threshold is predefined by a protocol or configured by the network side.

In some embodiments of this application, the NCR determines whether a beam failure occurs on the backhaul link. For example, the NCR-MT detects a specific reference signal to determine whether a beam failure occurs on the backhaul link. The specific reference signal may be explicitly configured by the network or implicitly determined based on a reference signal included in a TCI configuration of the backhaul link. The corresponding second threshold for determining a beam failure may be predefined by a protocol (for example, SINR corresponding to PDCCH BLER=10%) or configured by the network (for example, PDCCH BLER=b, where b<10%) or consistent with the first threshold of the control link.

It should be noted that the specific reference signal used to determine whether a beam failure occurs on the backhaul link is a reference signal transmitted on the control link. Because the Fwd module corresponding to the backhaul link does not perform decoding processing, for BFD on the backhaul link, a specific reference signal is received through the control link and measured, and a measurement result is used as a measurement result of the backhaul link.

In an implementation, in a case that the second link is a link configured by the network side, that the first communication device obtains a BFD result of a second link includes either of the following:

(1) The first communication device uses the BFD result of the first link as the BFD result of the second link.

In some embodiments of this application, the NCR determines whether a beam failure occurs on the backhaul link. For example, if the beam of the backhaul link is configured by the network, the control link and the backhaul link use a same beam failure detection result. To be specific, if a beam failure occurs on the control link, it is also considered that a beam failure occurs on the backhaul link.

(2) The first communication device measures a second reference signal on the first link in a time period of performing BFD on the first link, and in a case that a measurement result of the second reference signal is lower than a second threshold, determines that a beam failure occurs on the second link, where
the second reference signal is explicitly configured or implicitly determined by a TCI configuration of the second link, and the second threshold is predefined by a protocol or configured by the network side.

In some embodiments of this application, the NCR determines whether a beam failure occurs on the backhaul link. For example, the NCR-MT performs beam failure detection on the backhaul ink in a time period of performing beam failure detection on the control link. The NCR-MT detects a specific reference signal to determine whether a beam failure occurs on the backhaul link. The specific reference signal may be explicitly configured by the network or implicitly determined based on the reference signal included in the TCI configuration of the backhaul link. In some embodiments, the network explicitly configures the NCR-MT to detect signal quality (such as RSRP, RSRQ, or SINR) of a specific reference signal on the control link. The specific reference signal (SSB or CSI-RS) represents channel quality of the backhaul link, and the corresponding reference signal may be explicitly configured by the network or configured by the TCI of the backhaul link. The NCR-MT reports a signal quality measurement result of the specific reference signal, and the reporting may be periodic or triggered by an event (the signal quality is lower than a threshold, where the threshold may be configured by the network or predefined by a protocol).

In an implementation, the first threshold is lower than a preset signal quality threshold, and/or the second threshold is lower than a preset signal quality threshold. In some embodiments, the preset signal quality threshold may be a preset PDSCH BBLER, for example, PDSCH BBLER=10%, or an SINR corresponding to PDCCH BLER=10%.

In some embodiments of this application, the first threshold used by the NCR to determine whether a beam failure occurs on the control link and the second threshold used by the NCR to determine whether a beam failure occurs on the backhaul link may be set to a threshold lower than a preset signal quality threshold, and the signal quality may be an equivalent PDCCH BLER, a PDSCH BBLER, or a measurement result of RSRP, RSRQ, or SINR. Types of signal quality are not limited in embodiments of this application.

In an implementation, that the first communication device performs a processing operation based on the BFD result of the first link and/or the BFD result of the second link includes:
in a case that the first communication device determines that a beam failure occurs on the first link and/or the second link, that is, if a beam failure is detected on the control link and/or the backhaul link, the first communication device performs at least any one of the following:

(1) The first communication device sets forwarding functions of the second link and the third link to a disabled state.

Forwarding functions of the NCR backhaul link and the access link enter a disabled state, and signal forwarding is not performed.

(2) The first communication device performs signal forwarding on the second link and the third link by using predefined beams.

The NCR backhaul link and the access link use predefined beams for signal forwarding. The predefined beams may be beams used for forwarding the SSB (including a receive beam of the backhaul link and a transmit beam of the access link), or beams corresponding to a predefined physical channel on the control link (such as a beam/TCI configuration corresponding to a CORESET #0).

(3) In a case that the first communication device determines that no beam failure occurs on the first link and that a beam failure occurs on the second link, the first communication device reports, through the first link, that the beam failure occurs on the second link.

If a beam failure is detected on the backhaul link, the NCR reports a beam failure on the backhaul link through the control link.

(4) In a case that the first communication device determines that beam failures occur on the first link and the second link, the first communication device performs beam recovery through a beam failure recovery BFR procedure of the first link.

If a beam failure is detected on the control link, the NCR performs beam recovery through a BFR procedure.

In an implementation, the method further includes:
(1) in the case that the first communication device determines that no beam failure occurs on the first link and that a beam failure occurs on the second link, reporting candidate beams of the second link through the first link; or
(2) in the case that the first communication device determines that beam failures occur on the first link and the second link, reporting candidate beams of the second link through the BFR procedure of the first link.

In an implementation, after the performing beam recovery through a BFR procedure, the method further includes:
the first communication device performs a configuration based on a configuration from the network side, that is, after the control link performs the BFR procedure, the network reconfigures corresponding parameters for the backhaul link and the access link. For example, at least one of the following is configured:

(1) A beam of the third link and an enable time corresponding to the beam of the third link, where the third link is the access link between the second module and the terminal side,
that is, a beam of the access link and a corresponding enable time, and in some embodiments, if there is no explicit configuration, an original configuration is used.

If the beam of the access link is configured to correspond to N beams in a time period, the N beams divide the time period into N equal parts in a time division multiplexing mode, where the N equal parts are associated with the N beams respectively. The association may be performed in ascending order of numbers of the N beams, or based on an indicated order of the N beams, or according to other predefined rules. In some embodiments, for a time period configured with a periodicity, N beams are sequentially associated with the time period of the periodicity based on N times the periodicity.

(2) An enable time of the forwarding function of the second link, where a disable time of the forwarding function of the second link may also be configured,
that is, an enable time and a disable time of the forwarding function of the NCR, and if there is no explicit configuration, an original configuration is used.

(3) A signal amplification coefficient of the second module,
that is, a signal amplification coefficient of the NCR-Fwd, where if there is no explicit configuration, an original configuration is used.

(4) A beam configuration of the second link,
that is, a beam configuration of the NCR backhaul link.

In an implementation, that the first communication device performs a processing operation based on the BFD result of the first link and/or the BFD result of the second link includes:
in a case that the first communication device determines that no beam failure occurs on the first link and that a beam failure occurs on the second link, the first communication device measures candidate beams of the second link, and reports a beam with a measurement result greater than a third threshold, among the candidate beams, to the network side, where
the third threshold is predefined by a protocol or configured by the network side.

In some embodiments of this application, when BFD occurs on the backhaul link but not on the control link, the NCR-MT measures candidate beams of the backhaul link, and selects a beam (corresponding TCI) that meets a predefined condition and reports the beam to a base station. The predefined condition may be that channel quality (for example, SINR/RSRP/RSRQ) exceeds the third threshold.

In an implementation, in a case that the first communication device maintains connections to a plurality of network-side nodes, and that the first communication device determines that a beam failure occurs on the first link or the second link with a first node among the plurality of network-side nodes, that is, if the NCR maintains connections to a plurality of base stations or a plurality of TRPs, when a beam failure occurs on a control link or a backhaul link between the NCR and the first node (a base station or a TRP), the method further includes at least one of the following:

(1) The first module of the first communication device reports the beam failure between the first communication device and the first node through a second node among the plurality of network-side nodes.

The NCR-MT reports BFD between the NCR and the first node through the second node (base station or TRP).

(2) The first communication device stops forwarding an uplink signal and a downlink signal corresponding to the first node.

The NCR stops forwarding the uplink signal and the downlink signal corresponding to the first node.

(3) The first communication device performs signal forwarding by using a beam configuration corresponding to the second node.

The NCR performs signal forwarding by using the beam configuration corresponding to the second node. When BFD occurs on the NCR and the first node, a beam corresponding to the second node is used to replace a beam corresponding to the first node for performing signal forwarding, and in this case, a signal from the second node is forwarded. It is equivalent to allocating time resources originally allocated to the first node, to the second node for use. (The underlying terminal does not perceive a change of a signal source of the first node or the second node).

(4) The first communication device configures beams and uplink and downlink slots of the second link and the third link based on configuration information from the second node, where the third link is the access link between the second module and the terminal side; and
the NCR receives the configuration information from the second node, and configures beams and uplink and downlink slots of the backhaul link and the access link.

In an implementation, that the first communication device performs a processing operation based on the BFD result of the first link and/or the BFD result of the second link includes:
in a case that the first communication device determines that a beam failure occurs on the first link and/or the second link, the second module performs a processing operation based on a preconfiguration from the network side, that is, a gNB may preconfigure a forwarding behavior of the NCR-fwd after BFD is determined, and the processing operation includes any one of the following:
(1) stopping forwarding;
(2) performing forwarding by using default parameters with preset values; determining a beam of the NCR backhaul link in a case of BFD according to a predefined rule, for example, selecting one TCI configuration, according to a default rule, from a TCI configuration set configured for the control link, and using a beam (TCI configuration) corresponding to the CORESET #0 on the NCR control link or using an SSB with highest SSB signal quality as a QCL reference, where an amplification coefficient of the backhaul link is determined based on beam signal quality or remains unchanged; for example, the amplification coefficient is determined based on RSRP measured on the control link and transmit power (EIRP) of a predefined/preconfigured access link; or
(3) performing forwarding based on latest received power beam parameters.

In an implementation, in a process of performing the BFR procedure by the first communication device, or in a process of performing a configuration operation by the first communication device based on a configuration from the network side, a priority of a transmission and reception behavior of the first module is higher than a priority of a forwarding behavior of the second module.

In an implementation, the method further includes any one of the following:

(1) In the process of performing the BFR procedure, keeping a forwarding function of the second module in a disabled state, and after performing BFR, enabling the forwarding function of the second module based on an explicit notification from the network side.

If the forwarding function of the NCR-fwd is in the disabled state in the period of BFR, after the NCR-MT performs BFR, the base station explicitly instructs the NCR-fwd to enable the forwarding function.

(2) In the process of performing the BFR procedure, keeping the forwarding function of the second module in the disabled state, and after performing BFR, enabling the forwarding function of the second module based on an implicit notification from the network side.

If the forwarding function of the NCR-fwd is in the disabled state in the period of BFR, after the NCR-MT performs BFR, the base station implicitly instructs the NCR-fwd to enable the forwarding function, that is, after the NCR-MT determines that BFR is successful, for example, the NCR-MT enables the forwarding function after receiving, from the base station, a first piece of control information of a beam determined based on BFR, where the control information may be sent by using RRC signaling, MAC signaling, or the PDCCH, and the control information may be control information for scheduling signal forwarding of the NCR-Fwd (further, control information scrambled with a specific RNTI).

(3) In the process of performing the BFR procedure, keeping the forwarding function of the second module in the disabled state, and after performing BFR, enabling the forwarding function of the second module based on a time point indicated in reconfiguration information of the second module from the network side or based on a time point predefined by a protocol.

If the forwarding function of the NCR-fwd is in the disabled state in the period of BFR, after the NCR-MT performs BFR, the base station sends the reconfiguration information of the NCR-fwd, but after completing the reconfiguration of the NCR-fwd, the NCR enables the forwarding function of the NCR-fwd based on a time point indicated in a reconfiguration or based on a time point predefined by a protocol (for example, an X^{th} time unit after a slot corresponding to the reconfiguration information).

In an implementation, the method further includes:

(1) In a case that an RLF timer is started for the first link, or that the RLF timer expires, the second module stops signal forwarding.

When an RLF timer T310 is started for the control link or a timer T310 expires, the NCR-Fwd stops signal forwarding.

(2) After reestablishing an RRC connection between the first link and the network side, restart the second module based on a configuration from the network side.

The NCR-Fwd is restarted based on the configuration from the network after waiting for reestablishing an RRC connection between the control link and the base station.

In an implementation, the method further includes:
the first module reports, through the first link, that the second module is in a disabled state, to request to enable the second module and/or request to reconfigure the second link and/or the third link, where
the third link is the access link between the second module and the terminal side.

In some embodiments of this application, the NCR-MT reports, through the control link, that the NCR-Fwd is in the disabled state, to request to enable the NCR-Fwd and/or request to reconfigure the backhaul link or the access link.

The beam failure processing method provided in the embodiments of this application may be performed by a beam failure processing apparatus. A beam failure processing apparatus provided in the embodiments of this application is described by assuming that the beam failure processing method is performed by the beam failure processing apparatus in the embodiments of this application.

Referring to FIG. 3, an embodiment of this application provides a beam failure processing apparatus 300. The apparatus is applied to a first communication device and includes:
a first execution module 301, configured to obtain, by the first communication device, a BFD result of a first link and a BFD result of a second link; and
a second execution module 302, configured to perform, by the first communication device, a processing operation based on the BFD result of the first link and/or the BFD result of the second link, where
the first communication device is a relay device between a network side and a terminal side, the first communication device includes a first module and a second module, the first link is a control link between the first module and the network side, and the second link is a backhaul link between the second module and the network side.

In some embodiments, the first execution module 301 is configured to:
measure, by the first communication device, a first reference signal on the first link; and
in a case that a measurement result of the first reference signal is lower than a first threshold, determine that a beam failure occurs on the first link, where
the first threshold is predefined by a protocol or configured by the network side.

In some embodiments, in a case that a beam of a physical channel on the second link is the same as a beam of a physical channel on the first link, the first execution module 301 is configured to perform either of the following:
using, by the first communication device, the BFD result of the first link as the BFD result of the second link; and
measuring, by the first communication device, a second reference signal on the first link, and in a case that a measurement result of the second reference signal is lower than a second threshold, determining that a beam failure occurs on the second link, where
the second reference signal is explicitly configured or implicitly determined by a transmission configuration indicator TCI configuration of the second link, and the second threshold is predefined by a protocol or configured by the network side.

In some embodiments, in a case that the second link is a link configured by the network side, the first execution module 301 is configured to perform either of the following:
using, by the first communication device, the BFD result of the first link as the BFD result of the second link; and
measuring, by the first communication device, a second reference signal on the first link in a time period of performing BFD on the first link, and in a case that a measurement result of the second reference signal is lower than a second threshold, determining that a beam failure occurs on the second link, where
the second reference signal is explicitly configured or implicitly determined by a TCI configuration of the second link, and the second threshold is predefined by a protocol or configured by the network side.

In some embodiments, the first threshold is lower than a preset signal quality threshold, and/or the second threshold is lower than a preset signal quality threshold.

In some embodiments, the second execution module 302 is configured to:
in a case that the first communication device determines that a beam failure occurs on the first link and/or the second link, perform, by the first communication device, any one of the following:
setting, by the first communication device, forwarding functions of the second link and a third link to a disabled state;
performing, by the first communication device, signal forwarding on the second link and the third link by using predefined beams;
in a case that the first communication device determines that no beam failure occurs on the first link and that a beam failure occurs on the second link, reporting, through the first link, that the beam failure occurs on the second link; or
in a case that the first communication device determines that beam failures occur on the first link and the second link, performing beam recovery through a beam failure recovery BFR procedure of the first link, where
the third link is an access link between the second module and the terminal side.

In some embodiments, the apparatus further includes:
a third execution module, configured to:
in the case that the first communication device determines that no beam failure occurs on the first link and that a beam failure occurs on the second link, report candidate beams of the second link through the first link; or
in the case that the first communication device determines that beam failures occur on the first link and the second link, report candidate beams of the second link through the beam failure recovery BFR procedure of the first link. In some embodiments, the apparatus further includes:
a fourth execution module, configured to configure, by the first communication device, at least one of the following based on a configuration from the network side after beam recovery is performed through the BFR procedure:
a beam of the third link and an enable time corresponding to the beam of the third link;
an enable time of the forwarding function of the second link;
a signal amplification coefficient of the second module; or
a beam configuration of the second link, where
the third link is the access link between the second module and the terminal side.

In some embodiments, the second execution module 302 is configured to:
in a case that the first communication device determines that no beam failure occurs on the first link and that a beam failure occurs on the second link, measure, by the first communication device, candidate beams of the second link, and report a beam with a measurement result greater than a third threshold, among the candidate beams, to the network side, where
the third threshold is predefined by a protocol or configured by the network side.

In some embodiments, the apparatus further includes:
a fifth execution module, configured to perform at least one of the following in a case that the first communication device maintains connections to a plurality of network-side nodes, and that the first communication device determines that a beam failure occurs on the first link or the second link with a first node among the plurality of network-side nodes:
reporting, by the first module of the first communication device, the beam failure between the first communication device and the first node through a second node among the plurality of network-side nodes;
stopping forwarding, by the first communication device, an uplink signal and a downlink signal corresponding to the first node;
performing, by the first communication device, signal forwarding by using a beam configuration corresponding to the second node; or
configuring, by the first communication device, beams and uplink and downlink slots of the second link and a third link based on configuration information from the second node, where
the third link is an access link between the second module and the terminal side.

In some embodiments, the second execution module 302 is configured to:
in a case that the first communication device determines that a beam failure occurs on the first link and/or the second link, perform, by the second module, any one of the following based on a preconfiguration from the network side:
stopping forwarding;
performing forwarding by using default parameters with preset values; or
performing forwarding based on latest received power beam parameters.

In some embodiments, in a process of performing the BFR procedure by the first communication device, or in a process of performing a configuration operation by the first communication device based on a configuration from the network side, a priority of a transmission and reception behavior of the first module is higher than a priority of a forwarding behavior of the second module.

In some embodiments, the apparatus further includes:
a sixth execution module, configured to perform any one of the following:
in the process of performing the BFR procedure, keeping a forwarding function of the second module in a disabled state, and after performing BFR, enabling the forwarding function of the second module based on an explicit notification from the network side;
in the process of performing the BFR procedure, keeping the forwarding function of the second module in the disabled state, and after performing BFR, enabling the forwarding function of the second module based on an implicit notification from the network side; or
in the process of performing the BFR procedure, keeping the forwarding function of the second module in the disabled state, and after performing BFR, enabling the forwarding function of the second module based on a time point indicated in reconfiguration information of the second module from the network side or based on a time point predefined by a protocol.

In some embodiments, the apparatus further includes:
a seventh execution module, configured to perform either of the following:
in a case that an RLF timer is started for the first link, or that the RLF timer expires, stopping, by the second module, signal forwarding; and
after reestablishing an RRC connection between the first link and the network side, restarting the second module based on a configuration from the network side.

In some embodiments, the apparatus further includes:
an eighth execution module, configured to report, by the first module through the first link, that the second module is in a disabled state, to request to enable the second module and/or request to reconfigure the second link and/or a third link, where
the third link is an access link between the second module and the terminal side.

The beam failure processing apparatus in embodiments of this application may be an electronic device, for example, an electronic device with an operating system, or may be a component in an electronic device, for example, an integrated circuit or a chip. The electronic device may be a terminal, or may be other devices than a terminal. For example, the terminal may include but is not limited to the foregoing illustrated type of the terminal 11. The other devices may be a server, a network attached storage (NAS), and the like. This is not specifically limited in embodiments of this application.

The beam failure processing apparatus provided in embodiments of this application can implement each process implemented in the method embodiment in FIG. 2, with the same technical effect achieved. To avoid repetition, details are not described herein again.

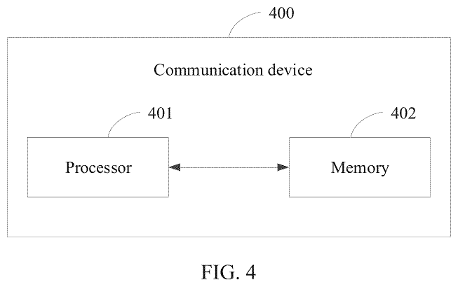

As shown in FIG. 4, an embodiment of this application further provides a communication device 400, including a processor 401 and a memory 402. The memory 402 stores a program or instructions capable of running on the processor 401. When the program or instructions are executed by the processor 401, the steps of the foregoing embodiment of the beam failure processing method are implemented, with the same technical effect achieved. To avoid repetition, details are not described herein again.

An embodiment of this application further provides a readable storage medium. The readable storage medium stores a program or instructions. When the program or instructions are executed by a processor, each process of the foregoing method embodiment is implemented, with the same technical effect achieved. To avoid repetition, details are not described herein again.

The processor is a processor in the terminal in the foregoing embodiment. The readable storage medium includes a computer-readable storage medium, for example, a computer Read-Only Memory (ROM), a Random Access Memory (RAM), a magnetic disk, or an optical disc.

In addition, an embodiment of this application provides a chip. The chip includes a processor and a communication interface. The communication interface is coupled to the processor. The processor is configured to run a program or instructions to implement each process of the foregoing method embodiment, with the same technical effect achieved. To avoid repetition, details are not described herein again.

It should be understood that the chip provided in embodiments of this application may also be referred to as a system-level chip, a system chip, a chip system, a system-on-chip, or the like.

In addition, an embodiment of this application provides a computer program or program product. The computer program or program product is stored in a storage medium. The computer program or program product is executed by at least one processor to implement each process of the foregoing method embodiment, with the same technical effect achieved. To avoid repetition, details are not described herein again.

An embodiment of this application further provides a communication system, including a terminal, a network device, and a first communication device, where the terminal communicates with the network device through the first communication device, and the first communication device can be configured to perform the steps of the method on the first communication device side.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude existence of other identical elements in the process, method, article, or apparatus that includes the element. In addition, it should be noted that the scope of the method and apparatus in the implementations of this application is not limited to performing the functions in an order shown or discussed, and may further include performing the functions in a substantially simultaneous manner or in a reverse order depending on the functions used. For example, the method described may be performed in an order different from that described, and various steps may be added, omitted, or combined. In addition, features described with reference to some examples may be combined in other examples.

According to the foregoing description of the implementations, a person skilled in the art may clearly understand that the methods in the foregoing embodiments may be implemented by using software in combination with a necessary general hardware platform, and may be implemented by using hardware. Based on such an understanding, the technical solutions of this application essentially or the part contributing to the prior art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. Inspired by this application, a person of ordinary skill in the art may develop many other manners without departing from principles of this application and the protection scope of the claims, and all such manners fall within the protection scope of this application.

What is claimed is:

1. A method for beam failure processing, comprising:
obtaining, by a first communication device, a beam failure detection (BFD) result of a first link; and
performing, by the first communication device, a processing operation based on the BFD result of the first link,
wherein the first communication device is a relay device between a network side and a terminal side, the first communication device comprises a first module, and the first link is a control link between the first module and the network side.

2. The method according to claim 1, wherein the obtaining, by a first communication device, a BFD result of a first link comprises:
measuring, by the first communication device, a first reference signal on the first link; and
when a measurement result of the first reference signal is lower than a first threshold, determining that a beam failure occurs on the first link,
wherein the first threshold is predefined by a protocol or configured by the network side.

3. The method according to claim 2, wherein the first threshold is lower than a preset signal quality threshold.

4. The method according to claim 1, wherein the performing, by the first communication device, a processing operation based on the BFD result of the first link comprises:
when the first communication device determines that a beam failure occurs on the first link, setting, by the first communication device, forwarding functions of a second link and a third link to a disabled state.

5. The method according to claim 4, further comprising:
when the first communication device determines that no beam failure occurs on the first link and that a beam failure occurs on the second link, reporting candidate beams of the second link through the first link; or
when the first communication device determines that beam failures occur on the first link and the second link, reporting candidate beams of the second link through a beam failure recovery (BFR) procedure of the first link.

6. The method according to claim 5, further comprising: configuring, by the first communication device, at least one of the following based on a configuration from the network side:
a beam of the third link and an enable time corresponding to the beam of the third link;
an enable time of the forwarding function of the second link;
a signal amplification coefficient of a second module; or
a beam configuration of the second link,
wherein the third link is an access link between the second module and the terminal side.

7. The method according to claim 1, wherein the performing, by the first communication device, a processing operation based on the BFD result of the first link comprises:
when the first communication device determines that no beam failure occurs on the first link and that a beam failure occurs on a second link, measuring, by the first communication device, candidate beams of the second link, and reporting a beam with a measurement result greater than a third threshold, among the candidate beams, to the network side,
wherein the third threshold is predefined by a protocol or configured by the network side.

8. The method according to claim 1, wherein when the first communication device maintains connections to a plurality of network-side nodes, and that the first communication device determines that a beam failure occurs on the first link with a first node among the plurality of network-side nodes, the method further comprises at least one of the following:
reporting, by the first module of the first communication device, the beam failure between the first communication device and the first node through a second node among the plurality of network-side nodes;
stopping forwarding, by the first communication device, an uplink signal and a downlink signal corresponding to the first node;
performing, by the first communication device, signal forwarding by using a beam configuration corresponding to the second node; or
configuring, by the first communication device, beams and uplink and downlink slots of a second link and a third link based on configuration information from the second node,
wherein the third link is an access link between a second module and the terminal side.

9. The method according to claim 1, wherein the performing, by the first communication device, a processing operation based on the BFD result of the first link comprises:
when the first communication device determines that a beam failure occurs on the first link, performing, by a second module, any one of the following based on a preconfiguration from the network side:
stopping forwarding;
performing forwarding by using default parameters with preset values; or
performing forwarding based on latest received power beam parameters.

10. The method according to claim 6, wherein
in a process of performing the BFR procedure by the first communication device, or in a process of performing a configuration operation by the first communication device based on a configuration from the network side, a priority of a transmission and reception behavior of the first module is higher than a priority of a forwarding behavior of the second module.

11. The method according to claim 1, further comprising:
in a process of performing a BFR procedure, keeping a forwarding function of a second module in a disabled state, and after performing BFR, enabling the forwarding function of the second module.

12. The method according to claim 1, further comprising:
when a radio link failure (RLF) timer is started for the first link, or that the RLF timer expires, stopping, by a second module, signal forwarding; and
after reestablishing a radio resource control (RRC) connection between the first link and the network side, restarting the second module based on a configuration from the network side.

13. The method according to claim 12, further comprising:
reporting, by the first module through the first link, that the second module is in a disabled state, to request to enable the second module.

14. A communication device, comprising a processor and a memory storing a program or an instruction that is capable of running on the processor, wherein the program or the instruction, when executed by the processor, causes the communication device to perform operations comprising:
obtaining a beam failure detection (BFD) result of a first link; and
performing a processing operation based on the BFD result of the first link,
wherein the communication device is a relay device between a network side and a terminal side, the communication device comprises a first module, and the first link is a control link between the first module and the network side.

15. The communication device according to claim 14, wherein the performing a processing operation based on the BFD result of the first link comprises:
when the communication device determines that a beam failure occurs on the first link, setting forwarding functions of a second link and a third link to a disabled state.

16. The communication device according to claim 14, wherein the operations further comprise:
in a process of performing a BFR procedure, keeping a forwarding function of a second module in a disabled state, and after performing BFR, enabling the forwarding function of the second module.

17. The communication device according to claim 14, wherein the operations further comprise:
when a radio link failure (RLF) timer is started for the first link, or that the RLF timer expires, stopping, by a second module, signal forwarding; and
after reestablishing a radio resource control (RRC) connection between the first link and the network side, restarting the second module based on a configuration from the network side.

18. A non-transitory computer-readable storage medium storing a program or an instruction, wherein the program or the instruction, when executed by a processor, causes the processor to perform operations comprising:
obtaining, by a communication device, a beam failure detection (BFD) result of a first link; and
performing, by the communication device, a processing operation based on the BFD result of the first link,
wherein the communication device is a relay device between a network side and a terminal side, the communication device comprises a first module, and the first link is a control link between the first module and the network side.

19. The non-transitory computer-readable storage medium according to claim 18, wherein the performing, by the communication device, a processing operation based on the BFD result of the first link comprises:
when the communication device determines that a beam failure occurs on the first link, setting forwarding functions of a second link and a third link to a disabled state.

20. The non-transitory computer-readable storage medium according to claim 18, wherein the operations further comprise:
in a process of performing a BFR procedure, keeping a forwarding function of a second module in a disabled state, and after performing BFR, enabling the forwarding function of the second module.
